(19) United States
(12) Patent Application Publication
(10) Pub. No.: US 2014/0175810 A1
(43) Pub. Date: Jun. 26, 2014

(54) LOCK ASSEMBLY

(71) Applicants: Harris Lambrou, Victoria (AU); Ian Bartos, Blackburn (AU)

(72) Inventors: Harris Lambrou, Victoria (AU); Ian Bartos, Blackburn (AU)

(73) Assignee: Gainsborough Hardware Industries Limited, Blackburn, Victoria (AU)

(21) Appl. No.: 14/119,608

(22) PCT Filed: Apr. 13, 2012
(86) PCT No.: PCT/AU2012/000386

§ 371 Date: Jan. 31, 2014

(30) Foreign Application Priority Data
Jul. 1, 2011 (AU) 2011902613

(51) Int. Cl. E05B 47/00; E05B 47/02

(52) U.S. Cl. CPC E05B 47/0001; E05B 47/026
USPC 292/144

(57) ABSTRACT

A lock assembly (20) including a lock bolt (28), a first hub (36), a first electrically powered hub locker assembly (64 to 70) and a first manually driven assembly (90 to 103). The lock bolt (28) is movable between a latching position and ah unlatching position. The first hub (36) is adapted to move the lock bolt (28) in response to movement of a first handle. The first electrically powered hub locker assembly (64 to 70) is positionable to selectively prevent or allow movement of the lock bolt (28) in response to torque being applied to the first handle. The first electrically powered hub locker assembly (64 to 70) is connectable to a first power source. The first manually driven assembly (90 to 103) is adapted for selectively preventing or allowing transmission of power from the first power source to the first electrically powered hub locker assembly (64 to 70).

### FIELD OF THE INVENTION

The present invention relates to a lock assembly.

The invention has been developed primarily for use with an electrically controllable and electrically powered mortice lock and will be described hereinafter with reference to this application. However, it will be appreciated that the invention is not limited to this particular use and is also suitable for use in other types of locks, such as surface mounted locks.

### BACKGROUND OF THE INVENTION

Electrically controllable and/or electrically powered locks are known. Such locks must be set to operate as either fail safe or fail secure. A fail safe lock automatically reverts to an unlocked state when its power supply is interrupted, for example during a power failure. A fail secure lock automatically reverts to a locked state when its power supply is interrupted.

One disadvantage of such known locks is that, when set to operate as fail safe, they are o unable to be used to lock the door in the absence of power. This requires a security guard or a separate manual lock to secure the door until power is returned.

Another disadavantage of such locks is, when set to operate as fail secure, they are unable to be used to unlock the door in the absence of power. Door opening is then only possible using a key operated latch retract function. However, this only temporarily unlatches the door whilst the key is pivoted by a user and the door returns to locked in the absence of same. This is inconvenient as it departs from the normal operation of a door and can present a safety issue as only key holders can open the door.

### OBJECT OF THE INVENTION

It is the object of the present invention to substantially overcome or at least ameliorate the above disadvantage, and/or to provide an alternative.

### SUMMARY OF THE INVENTION

Accordingly, in a first aspect, the present invention provides a lock assembly including:
a lock bolt movable between a latching position and an unlatching position;
a first hub adapted to move the lock bolt in response to movement of a first handle;
a first electrically powered hub locker assembly positionable to selectively prevent or allow movement of the lock bolt in response to torque being applied to the first handle, the first electrically powered hub locker assembly being connectable to a first power source; and
a first manually driven assembly adapted for selectively preventing or allowing to transmission of power from the first power source to the first electrically powered hub locker assembly.

The lock assembly preferably includes a housing and the lock bolt, the first hub, the first electrically powered hub locker assembly and the first manually driven assembly are mounted within the housing.

The first manually driven assembly is preferably driven by a key or a turn button.

In one form, the first electrically powered hub locker assembly is adapted for powered driving in a first direction to a first position and biased driving in a second direction opposite to the first direction to a second position, wherein the first electrically powered hub locker assembly remains at, or returns to, the second position when the first manually driven assembly is driven to prevent transmission of power to the first electrically powered hub locker assembly.

In another form, the first electrically powered hub locker assembly is adapted for powered driving in a first direction to a first position and powered driving in a second direction opposite to the first direction to a second position, wherein the electrically powered hub locker assembly remains at the position it was occupying when the first manually driven assembly is driven to prevent transmission of power to the first electrically powered hub locker assembly.

The lock assembly preferably includes:

a second hub adapted to move the lock bolt in response to movement of a second handle,

wherein the first electrically powered hub locker assembly is positionable to selectively prevent or allow movement of the lock bolt in response to torque being applied to the second handle.

The lock assembly preferably includes:

a second hub adapted to move the lock bolt in response to movement of a second handle; and

a second electrically powered hub locker assembly positionable to selectively prevent or allow movement of the lock bolt in response to torque being applied to the second handle, the second electrically powered hub locker assembly being connectable to the first power source,

wherein the first manually driven assembly is adapted for selectively preventing or allowing transmission of power from the first power source to the second electrically powered hub locker assembly.

The lock assembly preferably includes:
a second hub adapted to move the lock bolt in response to movement of a second handle; and
a second electrically powered hub locker assembly positionable to selectively prevent or allow movement of the lock bolt in response to torque being applied to the second handle, the second electrically powered hub locker assembly being connectable to a second power source,
wherein the first manually driven assembly is adapted for selectively preventing or allowing transmission of power from the second power source to the second electrically powered hub locker assembly.

In one form, the second electrically powered hub locker assembly is adapted for powered driving in a first direction to a first position and biased driving in a second direction opposite to the first direction to a second position, wherein the second electrically powered hub locker assembly remains at, or returns to, the second position when the first manually driven assembly is driven to prevent transmission of power to the second electrically powered hub locker assembly.

In another form, the second electrically powered hub locker assembly is adapted for powered driving in a first direction to a first position and powered driving in a second direction opposite to the first direction to a second position, wherein the second electrically powered hub locker assembly remains at The position it was occupying when the first manually driven assembly is driven to prevent transmission of power to the second electrically powered hub locker assembly.

The lock assembly preferably includes:
a second hub adapted to move the lock bolt in response to movement of a second handle;
a second electrically powered hub locker assembly positionable to selectively prevent or allow movement of the lock bolt in response to torque being applied to the second handle, the second electrically powered hub locker assembly, being connectable to a second power source; and
a second manually driven assembly adapted for selectively preventing or allowing transmission of power from the second power source to the second electrically powered hub locker assembly.

The second hub and the second electrically powered hub locker assembly are preferably also mounted within the housing.

The second manually driven assembly is preferably driven by a key or a turn button.

In one form, the second electrically powered hub locker assembly is adapted for powered driving in a first direction to a first position and biased driving in a second direction opposite to the first direction to a second position, wherein the second electrically powered hub locker assembly remains at, or returns to, the second position when the second manually driven assembly is driven to prevent transmission of power to the second electrically powered hub locker assembly.

In another form, the second electrically powered hub locker assembly is adapted for powered driving in a first direction to a first position and powered driving in a second direction opposite to the first direction to a second position, wherein the second electrically powered hub locker assembly remains at the position it was occupying when the second manually driven assembly is driven to prevent transmission of power to the second electrically powered hub locker assembly.

The first manually driven assembly is preferably adapted for moving the first electrically powered hub locker assembly from:
a position preventing movement of the lock bolt in response to torque being applied to the first handle to a position allowing movement of the lock bolt in response to torque being applied to the first handle; or
a position allowing movement of the lock bolt in response to torque being applied to the first handle to a position preventing movement of the lock bolt in response to torque being applied to the first handle.

The lock assembly preferably includes:
a second hub adapted to move the lock bolt in response to movement of a second handle,
wherein the first manually driven assembly is preferably adapted for moving the first electrically powered hub locker assembly from:
   a position preventing movement of the lock bolt in response to torque being applied to the second handle to a position allowing movement of the lock bolt in response to torque being applied to the second handle; or
   a position allowing movement of the lock bolt in response to torque being applied to the second handle to a position preventing movement of the lock bolt in response to torque being applied to the second handle.

The first electrically powered hub locker assembly preferably remains in the position it is moved to by the manual operation of the first manually driven assembly until subsequently acted upon by further manual operation of the first manually driven assembly.

The lock assembly preferably includes:
a second hub adapted to move the lock bolt in response to movement of a second handle;
a second electrically powered hub locker assembly positionable to selectively prevent or allow movement of the lock bolt in response to torque being applied to the second handle, and
wherein the first manually driven assembly is adapted for moving the second electrically powered hub locker assembly from:
   a position preventing movement of the lock bolt in response to torque being applied to the second handle to a position allowing movement of the lock bolt in response to torque being applied to the second handle; or
   a position allowing movement of the lock bolt in response to torque being applied to the second handle to a position preventing movement of the lock bolt in response to torque being applied to the second handle.

The second electrically powered hub locker assembly preferably remains in the position it is moved to by the manual operation of the first manually driven assembly until is subsequently acted upon by further manual operation of the first manually driven assembly.

The lock assembly preferably includes:
a second hub adapted to move the lock bolt in response to movement of a second handle;
a second electrically powered hub locker assembly positionable to selectively prevent or allow movement of the lock bolt in response to torque being applied to the second handle; and
a second manually driven assembly adapted for moving the second electrically powered hub locker assembly from:
   a position preventing movement of the lock bolt in response to torque being applied to the second handle to a position allowing movement of the lock bolt in response to torque being applied to the second handle; or
   a position allowing movement of the lock bolt in response to torque being applied to the second handle to a position preventing movement of the lock bolt in response to torque being applied to the second handle.

The second electrically powered hub locker assembly preferably remains in the position it is moved to by the manual operation of the second manually driven assembly until subsequently acted upon by further manual operation of the second manually driven assembly.

The first electrically powered hub locker assembly preferably includes a first driver in the form of a solenoid, a motor, a gravity driven device, a spring, an elastic band, a magnetic force, an electromagnetic force, an electrostatic force or any other force supplying or storage means.

The first driver is preferably an electrically powered pull type solenoid with a spring to biased return. Alternatively, the first driver is an electrically powered push type solenoid with a spring biased return. Further alternatively, the first driver is an electrically powered double keep type solenoid.

The second electrically powered hub locker assembly preferably includes a second driver in the form of a solenoid, a motor, a gravity driven device, a spring, an elastic band, a magnetic force, an electromagnetic force, an electrostatic force or any other force supplying or storage means.

The second driver is preferably an electrically powered pull type solenoid with a spring biased return. Alternatively, the second driver is an electrically powered push type solenoid with a spring biased return. Further alternatively, the second driver is an electrically powered double keep type solenoid.

The first manually driven assembly preferably includes a first engagement means settable in a first position engaging the first electrically powered hub locker assembly or in a second position not engaging the first electrically powered hub locker assembly, wherein movement of the first manually driven assembly whilst the first engagement means is in the first position causes movement in the first electrically powered hub locker assembly. The first engagement means is preferably slidable between the first position and the second position, most preferably in a direction parallel to the movement of the lock bolt.

The lock assembly preferably includes a front face with a first opening for providing access to the first engagement means. The first engagement means is preferably a first slidable block. The first slidable block preferably engages the first driven part in the first position and does not engage the first driven part in the second position.

The first manually driven assembly preferably includes a second engagement means settable in a first position engaging the second electrically powered hub locker assembly or in a second position not engaging the second electrically powered hub locker assembly, wherein movement of the first manually driven assembly whilst the second engagement means is in the first position causes movement in the second electrically powered hub locker assembly. The second engagement means is preferably slidable between the first position and the second position, most preferably in a direction parallel to the movement of the lock bolt. The lock assembly preferably includes a front face with a second opening for providing access to the second engagement means. The second engagement means is preferably a second slidable block. The second slidable block preferably engages the second driven part in the first position and does not engage the second driven part in the second position.

The second manually driven assembly preferably includes a second engagement means settable in a first position engaging the second electrically powered hub locker assembly or in a second position not engaging the second electrically powered hub locker assembly, wherein movement of the second manually driven assembly whilst the second engagement means is in the first position causes movement in the second electrically powered hub locker assembly. The second engagement means is preferably slidable between the first position and the second position, most preferably in a direction parallel to the movement of the lock bolt. The lock assembly preferably includes a front face with a second opening for providing access to the second engagement means. The second engagement means is preferably a second slidable block. The second slidable block preferably engages the second driven part in the first position and does not engage the second driven part in the second position.

In a second aspect, the present invention provides a lock assembly including:
a lock bolt movable between a latching position and an unlatching position;
a first hub adapted to move the lock bolt in response to movement of a first handle;
a first electrically powered hub locker assembly positionable to selectively prevent or allow movement of the lock bolt in response to torque being applied to the first handle; and
a first manually driven assembly adapted for moving the first electrically powered hub locker assembly from:
   a position preventing movement of the lock bolt in response to torque being applied to the first handle to a position allowing movement of the lock bolt in response to torque being applied to the first handle; or
   a position allowing movement of the lock bolt in response to torque being applied to the first handle to a position preventing movement of the lock bolt in response to torque being applied to the first handle.

The lock assembly preferably includes a housing and the lock bolt, the first hub, the first electrically powered hub locker assembly and the first manually driven assembly are mounted within the housing.

The first manually driven assembly is preferably driven by a key or a turn button.

The first electrically powered hub locker assembly preferably remains in the position it is moved to by the manual operation of the first manually driven assembly until subsequently acted upon by further manual operation of the first manually driven assembly.

The lock assembly preferably includes
a second hub adapted to move the lock bolt in response to movement of a second handle,
wherein the first electrically powered hub locker assembly is positionable to selectively prevent or allow movement of the lock bolt in response to torque being applied to the second handle, and
the first manually driven assembly is adapted for moving the first electrically powered hub locker assembly from:
   a position preventing movement of the lock bolt in response to torque being applied to the second handle to a position allowing movement of the lock bolt in response to torque being applied to the second handle; or
   a position allowing movement of the lock bolt in response to torque being applied to the second handle to a position preventing movement of the lock bolt in response to torque being applied to the second handle.

In one form, the first electrically powered hub locker assembly is preferably adapted for powered driving in a first direction and biased driving in a second direction opposite to the first direction, wherein the first manually driven assembly is adapted for driving all or part of the first electrically powered driver assembly in the first direction or the second direction.

In another form, the first electrically powered hub locker assembly is preferably adapted for powered driving in a first direction and powered driving in a second direction opposite to the first direction, wherein the first manually driven assembly is adapted for driving all or part of the first electrically powered driver assembly in the first direction or the second direction.

The lock assembly preferably includes:
a second hub adapted to move the lock bolt in response to movement of a second handle;
a second electrically powered hub locker assembly positionable to selectively prevent or allow movement of the lock bolt in response to torque being applied to the second handle; and
a second manually driven assembly adapted for moving the second electrically powered hub locker assembly from:
   a position preventing movement of the lock bolt in response to torque being applied to the second handle to a position allowing movement of the lock bolt in response to torque being applied to the second handle; or
   a position allowing movement of the lock bolt in response to torque being applied to the second handle to a position preventing movement of the lock bolt in response to torque being applied to the second handle.

The second hub and the second electrically powered hub locker assembly are preferably also mounted within the housing.

The second manually driven assembly is preferably driven by a key or a turn button.

In one form, the second electrically powered hub locker assembly is preferably adapted for powered driving in a first direction and biased driving in a second direction opposite to the first direction, wherein the second manually driven assembly is adapted for driving all or part of the second electrically powered driver assembly in the first direction or the second direction.

In another form, the second electrically powered hub locker assembly is preferably adapted for powered driving in a first direction and powered driving in a second direction opposite to the first direction, wherein the second manually driven assembly is adapted to for driving all or part of the second electrically powered driver assembly in the first direction or the second direction.

The first electrically powered hub locker assembly preferably includes a first driver in the form of a solenoid, a motor, a gravity driven device, a spring, an elastic band, a magnetic force, an electromagnetic force, an electrostatic force or any other force supplying or storage means.

The first driver is preferably an electrically powered pull type solenoid with a spring biased return. Alternatively, the first driver is an electrically powered push type solenoid with a spring biased return. Further alternatively, the first driver is an electrically powered double keep type solenoid.

The second electrically powered hub locker assembly preferably includes a second driver in the form of a solenoid, a motor, a gravity driven device, a spring, an elastic band, a magnetic force, an electromagnetic force, an electrostatic force or any other force supplying or storage means.

The second driver is preferably an electrically powered pull type solenoid with a spring biased return. Alternatively, the second driver is an electrically powered push type solenoid with a spring biased return. Further alternatively, the second driver is an electrically powered double keep type solenoid.

The first manually driven assembly preferably includes a first engagement means settable in a first position engaging the first electrically powered hub locker assembly or in a second position not engaging the first electrically powered hub locker assembly, wherein movement of the first manually driven assembly whilst the first engagement means is in the first position causes movement in the first electrically powered hub locker assembly. The first engagement means is preferably slidable between the first position and the second position, most preferably in a direction parallel to the movement of the lock bolt. The lock assembly preferably includes a front face with a first opening for providing access to the first engagement means. The first engagement means is preferably a first slidable block. The first slidable block preferably engages the first driven part in the first position and does not engage the first driven part in the second position.

The first manually driven assembly preferably includes a first engagement means settable in a first position engaging the second electrically powered hub locker assembly or in a second position not engaging the second electrically powered hub locker assembly, wherein movement of the first manually driven assembly whilst the first engagement means is in the first position causes movement in the second electrically powered hub locker assembly. The first engagement means is preferably slidable between the first position and the second position, most preferably in a direction parallel to the movement of the lock bolt. The lock assembly preferably includes a front face with a first opening for providing access to the first engagement means. The first engagement means is preferably a first slidable block. The first slidable block preferably enagages the first driven part in the first position and does not engage the first driven part in the second position.

The second manually driven assembly preferably includes a first engagement means settable in a first position engaging the second electrically powered hub locker assembly or in a second position not engaging the second electrically powered hub locker assembly, wherein movement of the second manually driven assembly whilst the first engagement means is in the first position causes movement in the second electrically powered hub locker assembly. The first engagement means is preferably slidable between the first position and the second position, most preferably in a direction parallel to the movement of the lock bolt. The lock assembly preferably includes a front face with a first opening for providing access to the first engagement means. The first engagement means is preferably a first slidable block. The first slidable block preferably engages the first driven part in the first position and does not engage the first driven part in the second position.

The first electrically powered hub locker assembly is preferably connectable to a first power source and the first manually driven assembly is adapted for selectively preventing or allowing transmission of power from the first power source to the first electrically powered hub locker assembly. The lock assembly preferably includes a first controller between the first power source and the first electrically powered hub locker assembly, wherein the first manually driven assembly is adapted for altering the first controller from an energising configuration, allowing power to be transmitted from the power source to the first electrically powered hub locker assembly, to a de-energising configuration, preventing power from being transmitted from the power source to the first electrically powered hub locker assembly.

In one form, the lock assembly includes:
a second hub adapted to move the lock bolt in response to movement of a second handle,
wherein the first electrically powered hub locker assembly is positionable to selectively prevent or allow movement of the lock bolt in response to torque being applied to the second handle.

In another form, the lock assembly includes:
a second hub adapted to move the lock bolt in response to movement of a second handle; and
a second electrically powered hub locker assembly positionable to selectively prevent or allow movement of the lock bolt in response to torque being applied to the second handle, the second electrically powered hub locker assembly being connectable to the first power source,
wherein the first manually driven assembly is adapted for selectively preventing or allowing transmission of power from the first power source to the second electrically powered hub locker assembly.

In a further form, the lock assembly includes:
a second hub adapted to move the lock bolt in response to movement of a second handle;
a second electrically powered hub locker assembly positionable to selectively prevent or allow movement of the lock bolt in response to torque being applied to the second handle, the second electrically powered hub locker assembly being connectable to a second power source; and
a second manually driven assembly adapted for selectively preventing or allowing transmission of power from the second power source to the second electrically powered hub locker assembly.

In one form, the first electrically powered hub locker assembly is adapted for powered driving in a first direction to a first position and biased driving in a second direction opposite to the first direction to a second position, wherein the first electrically powered hub locker assembly remains at, or returns to, the second position when the manually driven assembly is driven to prevent transmission of power to the first electrically powered hub locker assembly.

In another form, the first electrically powered hub locker assembly is adapted for powered driving in a first direction to a first position and powered driving in a second direction opposite to the first direction to a second position, wherein the first electrically powered hub locker assembly remains at the position it was occupying when the manually driven assembly is driven to prevent transmission of power to the first electrically powered hub locker assembly.

### BRIEF DESCRIPTION OF THE DRAWINGS

Preferred embodiments of the present invention will now be described, by way of an examples only, with reference to the accompanying drawings wherein:

FIG. 1 is a perspective view of a first embodiment of the lock assembly;

FIG. 2 is a perspective view of the lock assembly shown in FIG. 1 with the side cover removed, set to fail secure and not energised/locked;

FIG. 3 is a perspective view of the lock assembly shown in FIG. 2, with the faceplate removed;

FIG. 4 shows the lock assembly of FIG. 2 with bolts retracted via key override;

FIG. 5 shows the lock assembly of FIG. 2 modified to operate a key operated manual override function, and the key operated manual override function activated to override the first locked electrically powered hub locker assembly, unlocking the first hub and allow rotation thereof;

FIG. 6 shows the lock assembly of FIG. 5 with the first hub rotated and the bolts retracted;

FIG. 7 shows the lock assembly of FIG. 2 with the key operated manual override function deactivated;

FIG. 8 shows the lock assembly of FIG. 7 set to fail safe and not energised/unlocked;

FIG. 9 shows the lock assembly of FIG. 8 with the key operated manual override function activated to override the unlocked first electrically powered hub locker assembly, locking the first hub and preventing rotation thereof;

FIG. 10 shows the lock assembly of FIG. 2 set to fail secure and energised/unlocked, with the key operated manual override function deactivated;

FIG. 11 is a perspective view a second embodiment of a lock assembly set to fail secure and energised/unlocked;

FIG. 12 shows the lock assembly shown in FIG. 11 with the key operated manual override function activated to override and deenergise the first locked electrically powered hub locker assembly, locking the first hub and prevent rotation thereof; and

FIG. 13 is a perspective view of a third embodiment of a lock assembly with the key operated manual override function activated to override the first unlocked electrically powered hub locker assembly, locking the first hub and prevent rotation thereof.

### DETAILED DESCRIPTION OF THE PREFERRED EMBODIMENTS

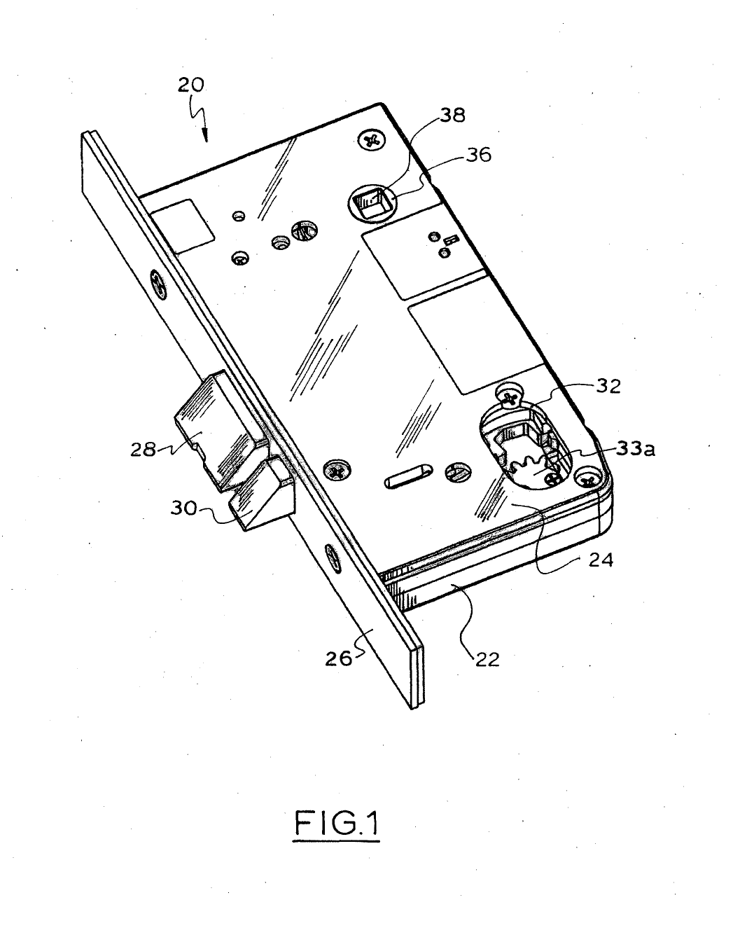

FIG. 1 shows an embodiment of an electrically controllable and electrically powered mortice lock assembly 20. The lock assembly 20 includes a housing 22 with a side cover 24 and a face plate 26. The lock assembly 20 is installed in a door with the housing 22 within a mortice void in the door and the face plate 26 adjacent to the non-hinged edge of the door, as is well understood by persons skilled in the art. A latch bolt 28 and an auxiliary bolt 30 pass through the faceplate 26 for engagement with a strike plate (not shown) in a door jamb, as is also well understood by persons skilled in the art.

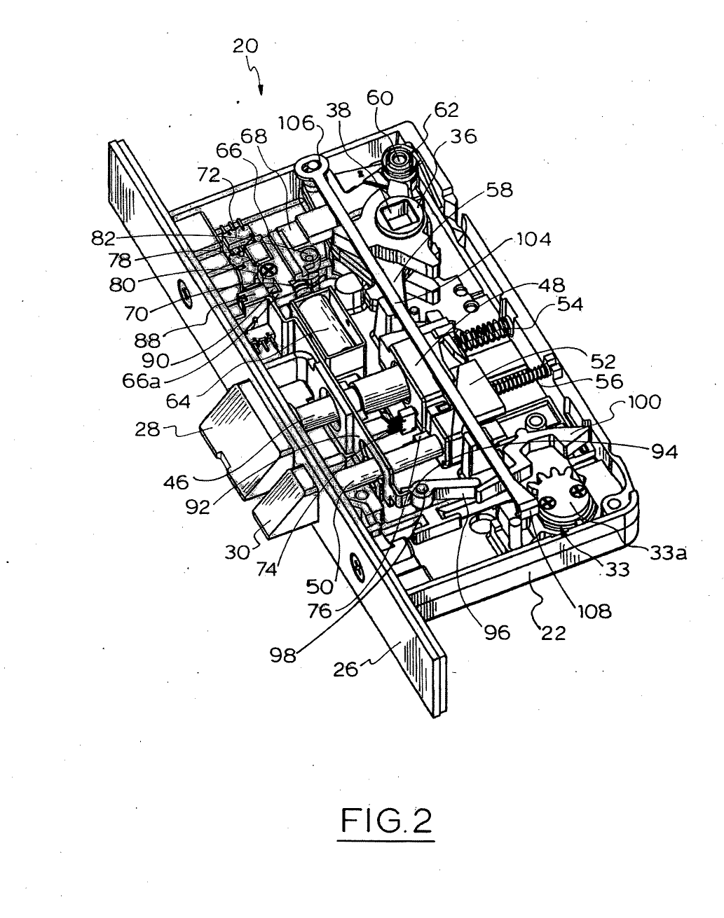

The lock assembly 20 also includes an opening 32 that receives a key cylinder assembly 33 therein (as shown in FIG. 2). The key cylinder assembly is retained within the opening 32 with a key cylinder retaining pin (not shown), as is also well understood by persons skilled in the art. The key cylinder assembly 33 includes a key cylinder cam 33a (as shown in FIG. 2). After the key cylinder assembly 33 has been inserted into the opening 32, and the key cylinder retaining pin inserted into the key cylinder assembly 33, the key cylinder retaining pin is prevented from releasing its engagement with the key cylinder assembly 33 by engagement of the faceplate 26 with the housing 22.

For ease of description, the side of the lock assembly 20 shown in FIG. 1 will be referred to as the first side and the opposite side as the second side. The edge near the faceplate 26 will be referred to as the front and its opposite edge the rear. The edge near the opening 32 will be referred to as the bottom and its opposite edge the top.

The lock assembly 20 also includes a first hub 36 with a square cross section opening 38 therein, which is adapted to engage with a square cross section drive shaft (not shown) of a first external knob, lever or other handle (not shown).

FIG. 2 shows the lock assembly 20 with the side cover 24 of the housing 22 removed. The latch bolt 28 is connected to a latch bolt shaft 46 which is in turn connected to a latch bolt carriage 48. The auxiliary bolt 30 is connected to an auxiliary bolt shaft 50 which is in turn connected to an auxiliary bolt carriage 52. The latch bolt 28 and the auxiliary bolt 30 are biased toward a latching position, as shown in FIG. 2, by a latch spring 54 and an auxiliary latch spring 56 respectively.

A carriage retraction arm 58 is pivotally mounted to the housing 22 by a shaft 60 and biased toward the position shown in FIG. 2 by a spring 62. The arm 58 can be moved to retract the latch bolt 28 and the auxiliary bolt 30 under certain conditions, in response to movement of the first or second handles or the key cylinder assembly, as will be described in more detail below.

FIG. 2 also shows a first electrically powered hub locker assembly comprising a first electrically powered solenoid 64 which is connected to a first motion transfer means 66 which is in turn connected to a first hub locker 68. The first solenoid 64 is of the pull type and also includes a first biasing spring 70. The first motion transfer means 66 includes a tab 66a, the function of which will be described in more detail below.

The lock assembly 20 also includes a second handle, a second hub and a second electrically powered hub locker assembly on its second side. The second electrically powered hub lock assembly comprises a second electrically powered solenoid which is connected to a second motion transfer means which is in turn connected to a second hub locker. The second electrically powered solenoid is also a pull type and includes a second biasing spring.

FIG. 2 also shows a first hub locking sensor 72 which is able to provide a signal indicative of the position of the first electrically powered hub locker assembly to allow remote signalling of the lock status of the first hub 36 to a remotely located controller or other internal control. A similar sensor is provided for the second electrically powered hub locker assembly. FIG. 2 also shows a latch bolt sensor 74 and an auxiliary bolt sensor 76, which similarly signal the position of the latch bolt 28 and the auxiliary bolt 30 respectively. Other sensors (not shown) can also be added as desired to other mechanical facets of the lock assembly 20, such as remotely signalling lock and/or door status or providing other internal control.

The construction and operation of the first and second electrically powered hub locker assemblies are identical and are described in the Applicant's Australian provisional patent application no. 2010903161 entitled “A lock assembly”, the relevant contents of which are incorporated herein by cross reference. Briefly, placing a screw 78 through opening 80 configures the movement of the hub locker 68 in response to the movement of its associated solenoid 64 in one direction and placing the screw 78 through opening 82 configures the movement of the hub locker 68 in response to the movement of its associated solenoid 64 in another, opposite, direction. As the first solenoid 64 is of the pull type, it retracts when energised and then relies on the first biasing spring 70 to extend it when not energised.

As shown in FIG. 2, when the first motion transfer means 66 of the first electrically powered hub locker assembly is configured with the screw 78 in the opening 80, and the associated solenoid 64 is not energised, the first hub locker 68 is driven by the solenoid spring 70 towards the first hub 36 to an extended position (as shown) engaging with and preventing rotation of (i.e. locking) the first hub 36. When the solenoid 64 is energised, the first hub locker 68 is driven away from the first hub 36 to a retracted position allowing rotation of (i.e. unlocking) the first hub 36. This is a fail secure setting.

When the first motion transfer means 66 is configured with the screw 78 in the opening 82, and the solenoid 64 is not energised, the first hub locker 68 is driven by the solenoid spring 70 away from the first hub 36 to the retracted position allowing rotation of (i.e. unlocking) the first hub 36. When the solenoid 64 is energised the first hub locker 68 is driven towards the first hub 36 to the advanced position engaging with and preventing rotation of (i.e. locking) the first hub 36. This is a fail safe setting.

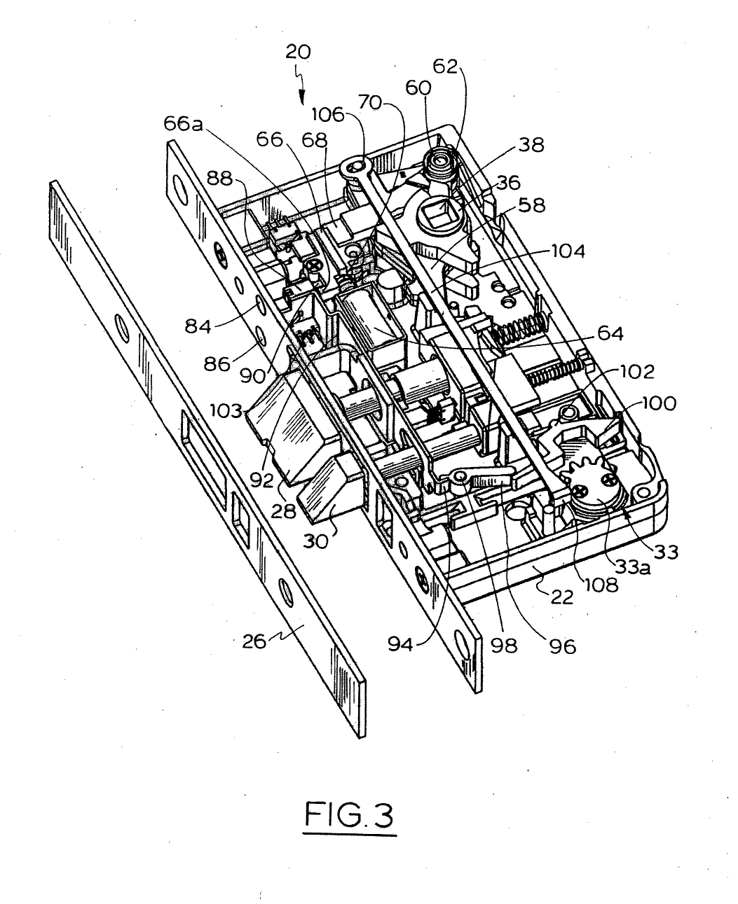

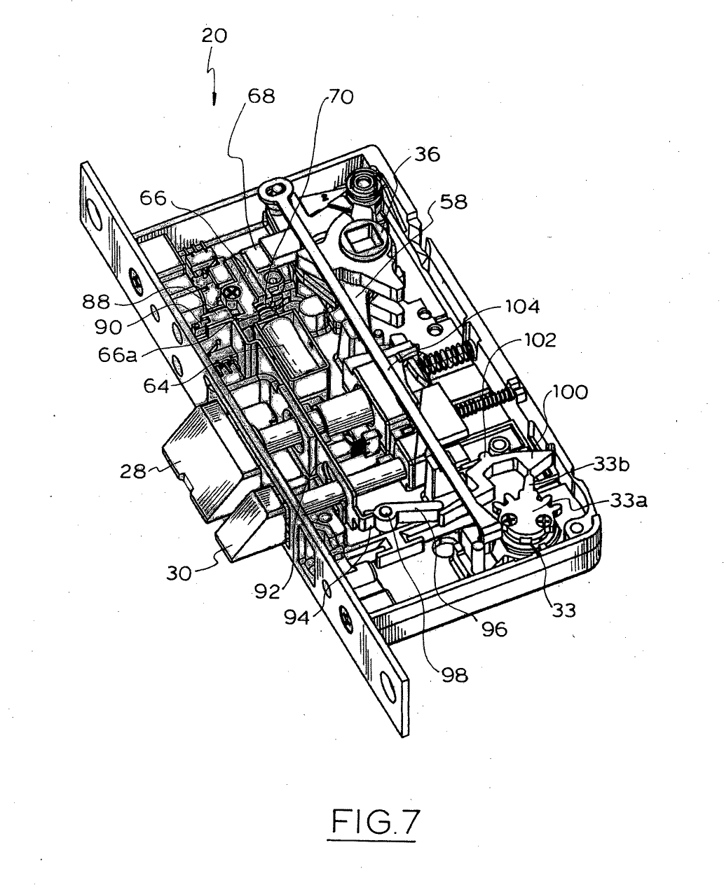

FIG. 3 shows the lock assembly 20 with the faceplate removed exposing a first adjustment port 84 and a second adjustment port 86. The first adjustment port 84 is aligned with a first lockbar block 88 which has a first lockbar 90 therein. The first lockbar 90 can be positioned relative to the first lockbar block 88 in an extended position (e.g. FIG. 3) or a retracted position (e.g. FIG. 7). The first lockbar block 88 is carried on one end of a manual override slide 92. The other end of the manual override slide 92 has a flange 94 which interacts with a lever 96, which pivots about a shaft 98. The lever 96 also interacts with key driven lever 100, which pivots about a shaft 102. A manual override sensor 103 is able to provide a signal indicative of the position of the manual override slide 92. The second adjustment port 84 similarly provides across to a second lockbar within a second lockbar block. The above described components together form a manually driven assembly able to provide a key operated manual override function. As will be described in more detail below, the key operated manual override function is activated, with respect to the first side of the lock assembly 20, by positioning the first lockbar 90 in the extended position and deactivated by positioning the first lockbar 90 in the retracted position. Similarly, the second adjustment port 86 is aligned with a second lockbar block which has a second lockbar therein. The second lockbar can also be positioned relative to the second lockbar block in an extended position or a retracted position. The second lockbar block is carried on the same end of the manual override slide 92 as the first lockbar block 90. The key operated manual override function is activated, with respect to the second side of the lock assembly 20, by positioning the second lockbar in the extended position and deactivated by positioning the second lockbar in the retracted position.

FIG. 3 also shows a key cylinder retraction bar 104. The key cylinder retraction bar 104 has a first end 106 connected to the carriage retraction arm 58 and a second end with a depending part 108.

As previously mentioned, FIG. 3 shows the lock assembly 20 set to fail secure and with the first solenoid 64 de-energised allowing the solenoid spring 70 to drive the first hub locker 68 into locking engagement with the first hub 36, preventing rotation of same. As a result, the first hub 36 can not be rotated to withdraw the bolts 28 and 30 and the lock assembly 20 is locked from the first side. FIG. 3 also shows the manual override slide 92 positioned towards the upper edge of the lock assembly 20 (hereafter the upper position) and with the lock bar 90 in the extended position, but not pushing on the tab 66a.

The key driven lever 100 is sitting rotated anti-clockwise so not pushing on lever 96 which in turn is not pushing on the flange 94 of the manual override slide 92. This allows the manual override slide 92 to remain in the upper position shown.

Referring to FIG. 3, the manual override slide 92 can be set to affect change only to the first, only to the second or to both of the first and second electrically powered hub locker assemblies of the lock assembly 20, as will now be described. Pushing a key cylinder retaining pin, or other suitable tool, through the first adjustment port 84 pushes the lock bar 90 into the extended position, adjacent to the tab 66a of the first motion transfer means 66. As a result, downward movement of the manual override slide 92 towards the bottom edge (hereafter the lower position) of the lock assembly 20 will also pull the tab 66a, and thus the remainder of the first motion transfer means 66, downwards and cause movement in the first hub locker 68 similar to that of the first solenoid 64 being retracted. However, if the lock bar 90 is pulled to the retracted position (e.g. see FIG. 7) then the lock bar tip 90 will no longer be adjacent to the tab 66a and movement of the manual override slide 92 will not affect the first motion transfer means 66 or the first hub locker 68 (see FIG. 7). The lock bar 90 is able to pulled to the retracted position by use of a hook tool (not shown) that is inserted through the adjustment port 84, into the lockbar 90, and then withdrawn towards the front of the lock assembly 20.

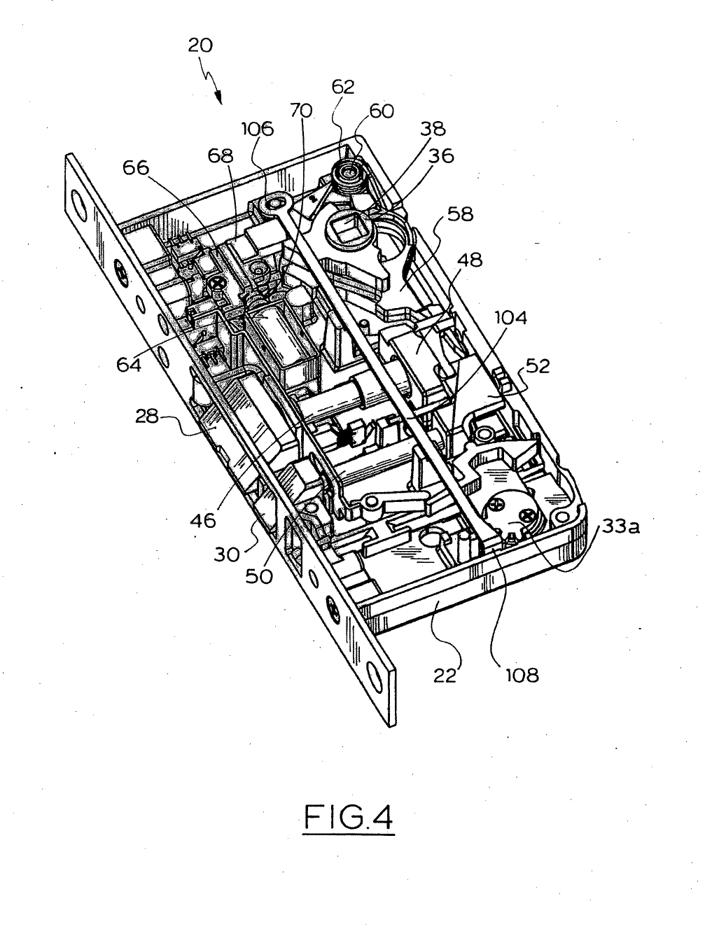

FIG. 4 shows the lock assembly 20 of FIG. 2 after the depending part 108 of the key cylinder retraction bar 104 has been driven towards the bottom edge of the lock assembly 20 by rotation of the key cylinder cam 33a of the key cylinder assembly 33 by a correct key. The resulting movement in the key cylinder retraction bar 104 pivots the carriage retraction arm 58 to withdraw the lock bolt 28 and the auxiliary bolt 30. It will be appreciated that this action, known as key override unlatching, withdraws the bolts 28 and 30 for door opening but, importantly, it does not unlock the lock assembly 20. Accordingly, as soon as torque is removed from the key used to rotate the key cylinder cam 33a, the springs 54 and 56 extend the bolts 28 and 30 respectively and return the lock to assembly 20 to the locked configuration shown in FIG. 2.

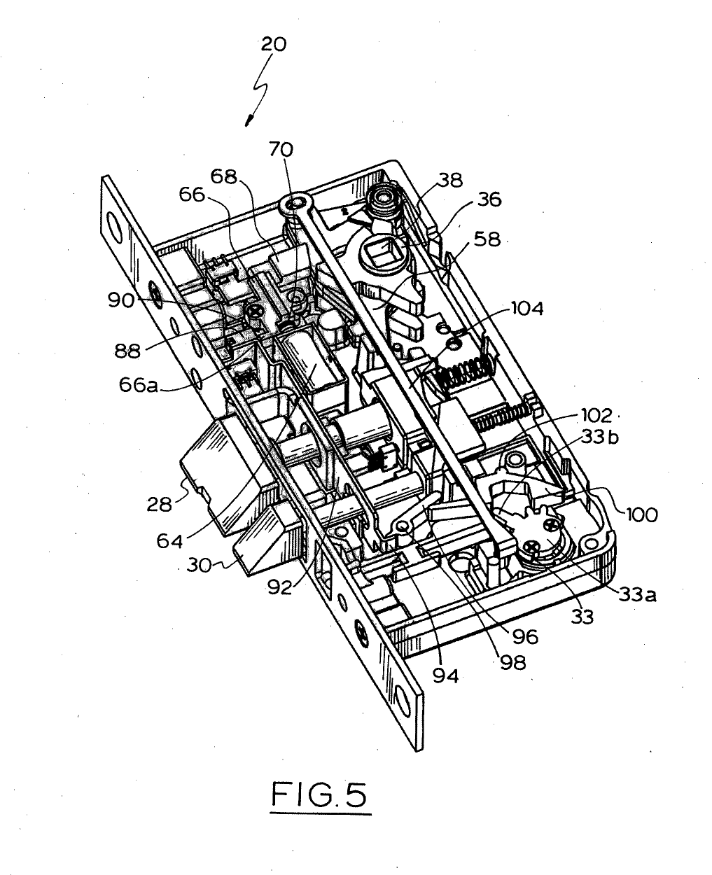

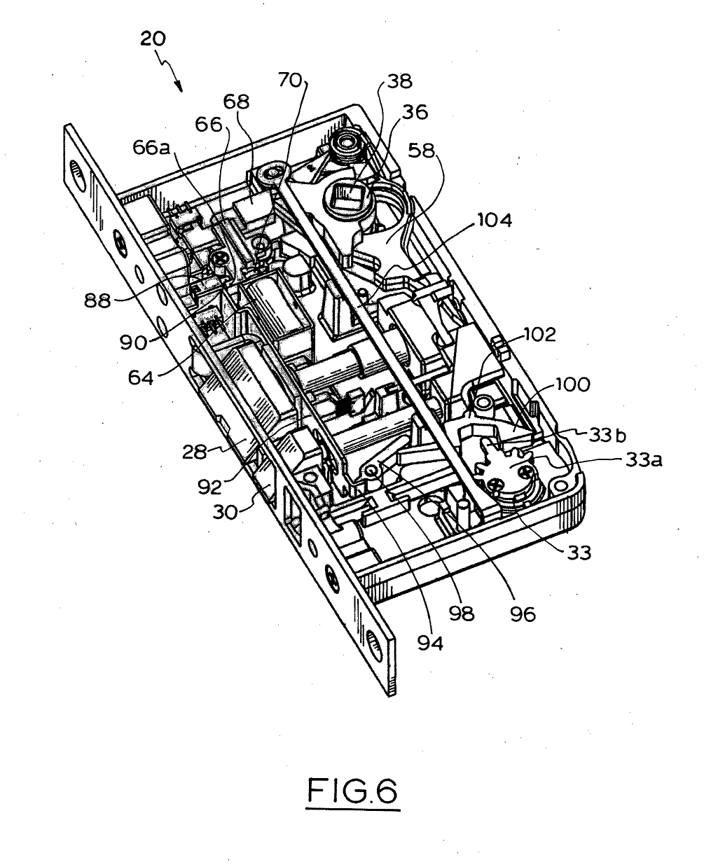

FIG. 5 shows the lock assembly 20 of FIG. 2 modified to operate a key operated manual override function by the addition of a revised key cylinder cam 33a that has an extension 33b thereon. The key operated manual override function is shown activated, by the first lockbar block 90 being in the extended position. FIG. 5 shows the key cylinder cam 33a being rotated by a correct key to a position which causes the key driven lever 100 to pivot clockwise which in turn causes the lever 96 to pivot anti-clockwise and pull the manual override slide 92 downwards toward the bottom edge of the lock assembly 20 into the lower position. The manual override slide 92 carries the lockbar block 88 and lockbar 90 downwards allowing the lockbar 90 to pull the tab 66a and thus the first motion transfer means 66 downwards. This in turn moves the first hub locker 68 to the retracted position. As a result, the first hub 36 is free to rotate and this rotation of the first hub 36 will retract the bolts 28 and 30 (as shown in FIG. 6) and the first side of the lock assembly 20 is unlocked. The manual override slide 92 will remain in the lower position shown, and thus keep the first side of the lock assembly 20 unlocked, until it is moved again by the correct key. The lock assembly 20 can be relocked by the use of the correct key (see FIG. 7) to rotate the key cylinder cam 33a in a clockwise direction to pivot the key driven lever 100 in an anti-clockwise direction and reverse the previously described movements. Once again, the manual override slide 92 will then remain in the upper position until further acted upon by the correct key.

FIG. 6 shows the lock assembly of FIG. 5 after rotation of the first hub 36 has caused the carriage retraction arm 58 to withdraw the bolts 28 and 30.

FIG. 7 shows the lock assembly 20 with the lockbar 90 pulled into the retracted position so that the lockbar 90 is no longer adjacent to the tab 66a. As a result, the key operated manual override function is deactivated and movement of the manual override slide 92 will have no affect on the first motion transfer means 66 or the first hub locker 68.

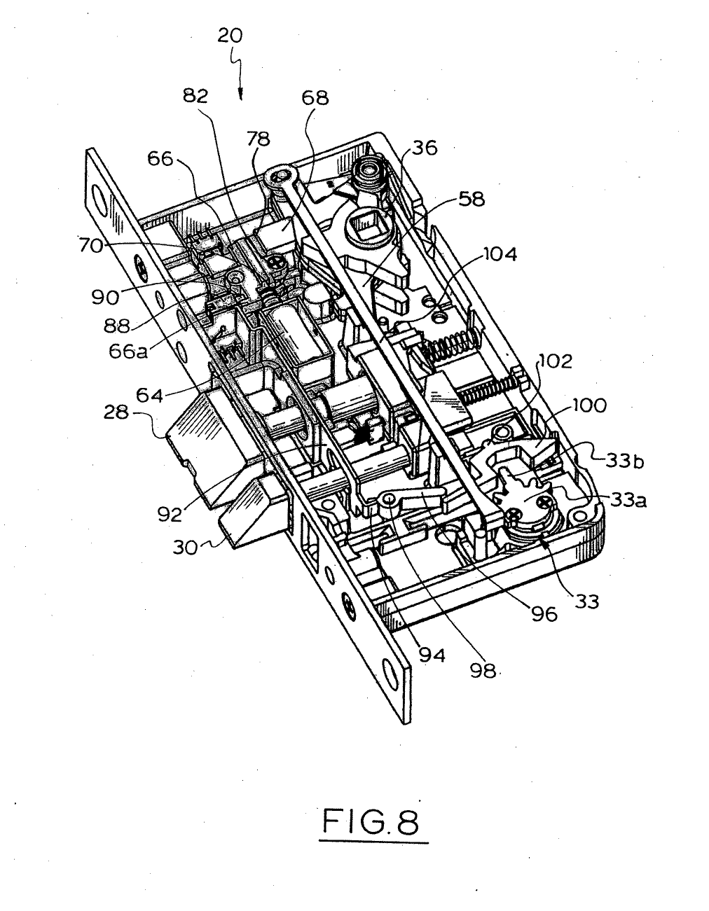

FIG. 8 shows the lock assembly 20 set to fail safe by the screw 78 being inserted within the opening 82. The solenoid 64 is shown not energised and the first hub locker 68 is thus shown being driven by the first solenoid spring 70 to the retracted position, allowing rotation of the first hub 36. In other words, the first side of the lock assembly 20 is to unlocked. The key operated manual override function is activated by the lockbar 90 being pushed into the extended position where it may engage the tab 66a of the first motion transfer means 66.

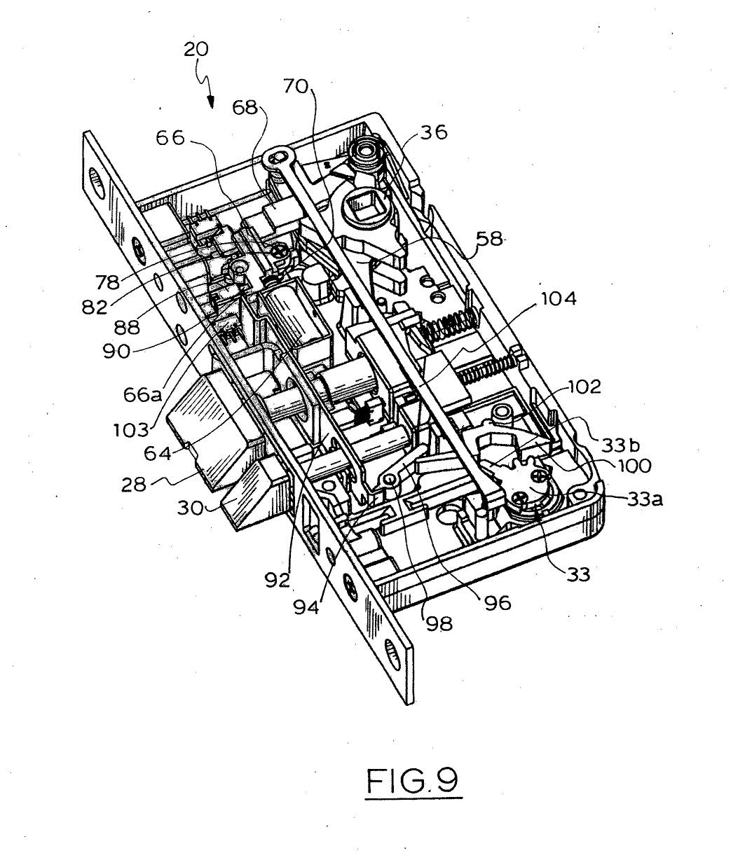

FIG. 9 shows the lock assembly 20 of FIG. 8 after the key operated manual override function has been used to manually lock the first side of the lock assembly 20. As shown, the key cylinder cam 33a has been pivoted by the correct key such that the extension 33a causes the key driven lever 100 to pivot in a clockwise direction causing the lever 96 to pivot in an anti-clockwise direction and in turn cause the manual override slide 92 to be driven downwards to the lower position. During this movement, the locking bar 90 abouts the tab 66a and causes the first motion transfer means 66 to drive the first hub locker 68 from the retracted position to the extended position, preventing rotation of the first hub 36. As a result, the first side of the lock assembly 20 is now locked. Once again, the manual override slide 92 will remain in the lower position, and thus keeps the first side of the lock assembly 20 locked, until it is moved again by a correct key.

The first side of the lock assembly 20 can be unlocked by use of a correct key to rotate the key cylinder cam 33a clockwise and drive the key driven lever 100 anti-clockwise and the lever 96 clockwise. This movement reverses the previous actions. Once again the manual override slide 92 will remain in the upper position until further acted upon by the correct key.

The position of the manual overrides slide 92 shown also activates the manual override sensor 103 which can provide a signal to cause further action. For example, the signal can be used to cause the removal of any external electrical drive, control or power signal from operating one or more of the first and second solenoids or can provide a signal notifying a control centre that the manual key override function has been used.

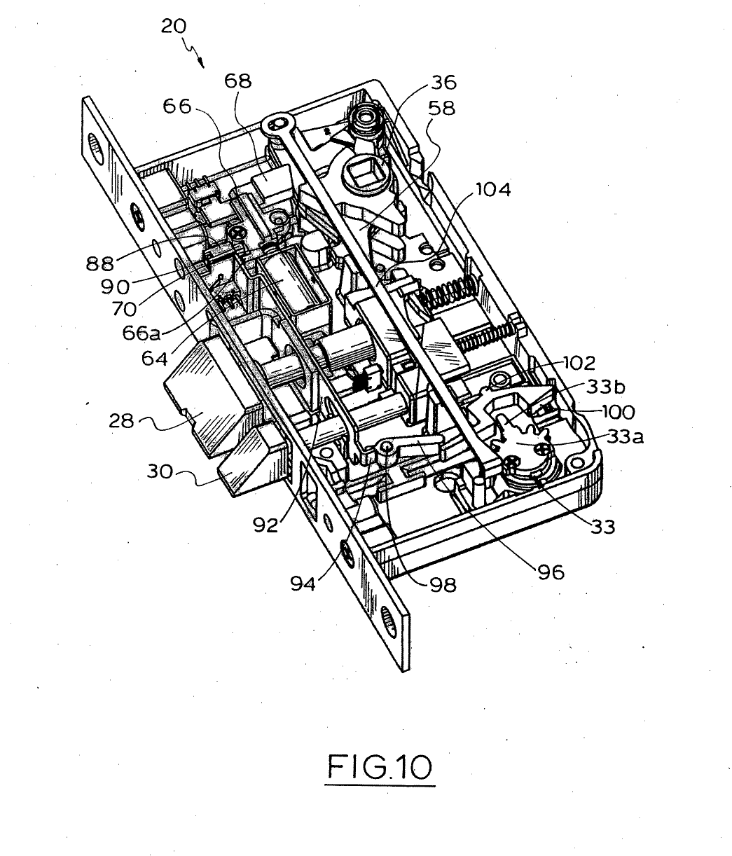

FIG. 10 shows the lock assembly 20 with the electrically operated locking components set to fail secure, as per FIG. 2 and FIG. 3, and with the first solenoid 64 energised and retracted so that the first side of the lock assembly 20 is unlocked. As shown, the manual override slide 92 is not affecting the lock assembly 20. If an external party gains access to the lock assembly's control system they may arrange for the lock assembly 20 to be left unlocked in order to gain unauthorised entry. In this situation, it is advantageous to be able to manually override this unlocked state and so secure the door. However, the manual override slide 92 as described so far cannot make any change to the state of the lock assembly 20 because the tab 66a and thus the first motion transfer means 66 is already in the position that it would be driven to by downwards movement of the manual override slider 92.

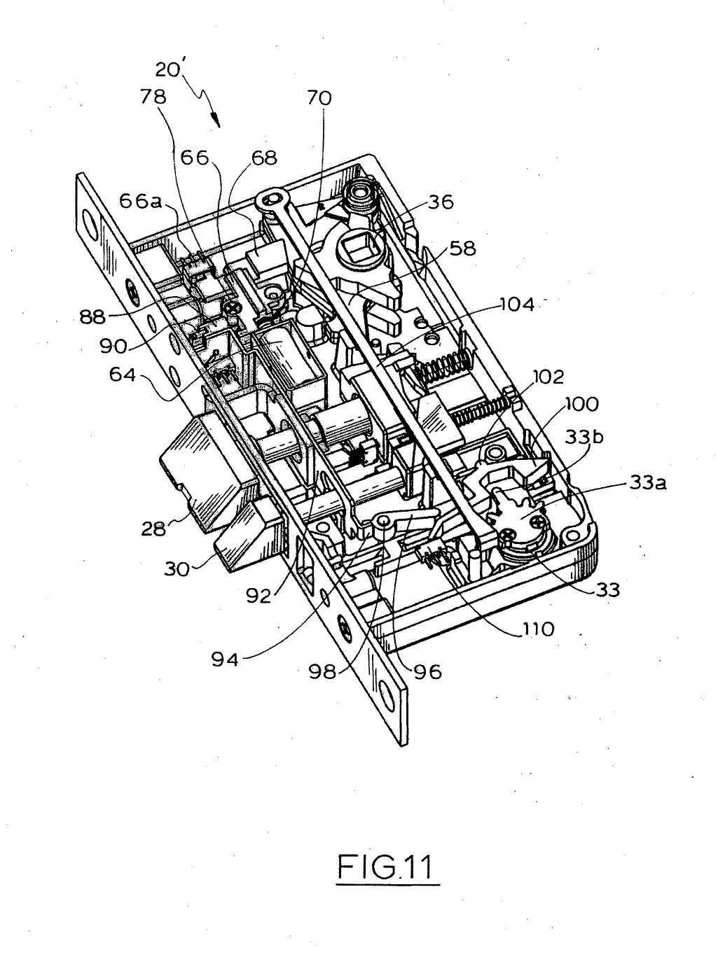

FIG. 11 shows a second embodiment of a lock assembly 20′ able to address the above situation by allowing for external electric control of the solenoids to be removed whilst leaving the hub locker 68 where the fail safe or fail secure configuration of the lock has positioned it. As a result, the lock assembly 20′ can be locked or unlocked using a key. In order to do so, the lock assembly 20′ includes a sensor 110 adapted to interact with an extended form of the key driven lever 100. FIG. 11 shows the lock assembly 20′ after the key cylinder cam 33a has been rotated by the correct key to pivot the key driven lever 100 anti-clockwise. In this position, the sensor 110 sends a signal that the key operated manual override function is not in use.

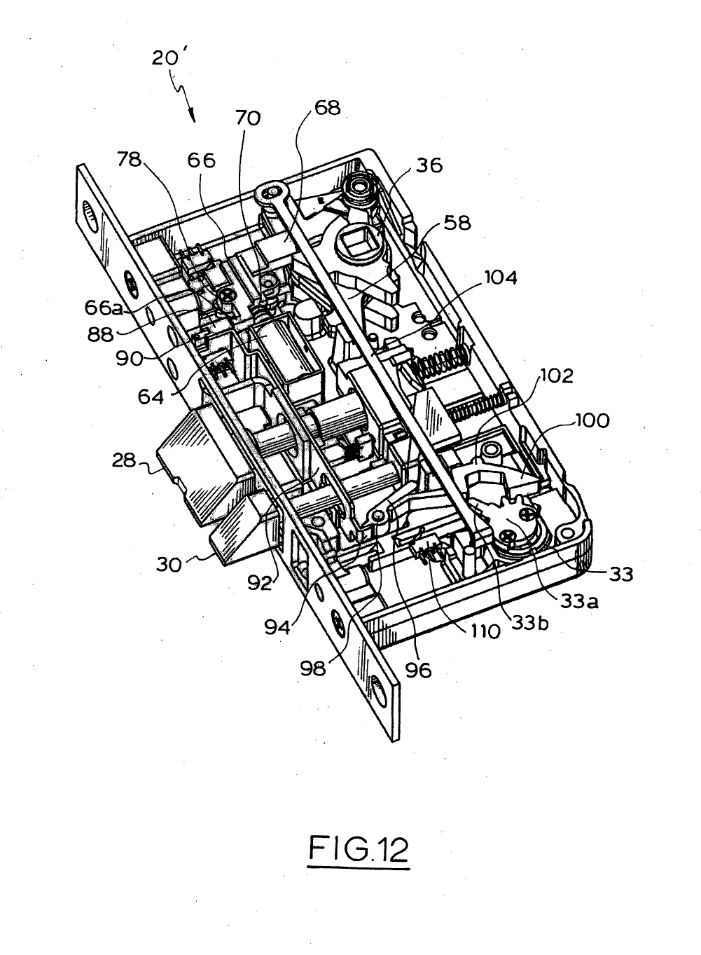

FIG. 12 shows the lock assembly FIG. 11 after the key cylinder cam 33a has been pivoted rotated by the correct key to pivot the key driven lever 100 clockwise. As previously described, the resulting movement in the manual override slide 92 has no influence on the first motion transfer means 66 or the first hub locker 68 as the locking bar 90 is in the withdrawn position. However, the triggering of the switch 110 by the movement of the key driven lever 100 sends a signal to the controller that the power supply to the first solenoid 64 should be removed. When the lock assembly 20 is configured as fail secure as shown, removing power from the solenoid 64 allows the spring 70 to drive the first motion transfer means 66 to cause the first hub locker 68 to engage with, and prevent rotation of, the first hub 36. This action locks the first side of the lock assembly 20′.

If the lock assembly 20 was configured as fail safe, the reverse would occur and the spring 70 would drive the first hub locker 68 from the engaged position to the withdrawn position, thereby unlocking the first side of the lock assembly 20′. Accordingly, the triggering of the switch 110 allows the lock state of the lock assembly 20′ to be (manually) reversed.

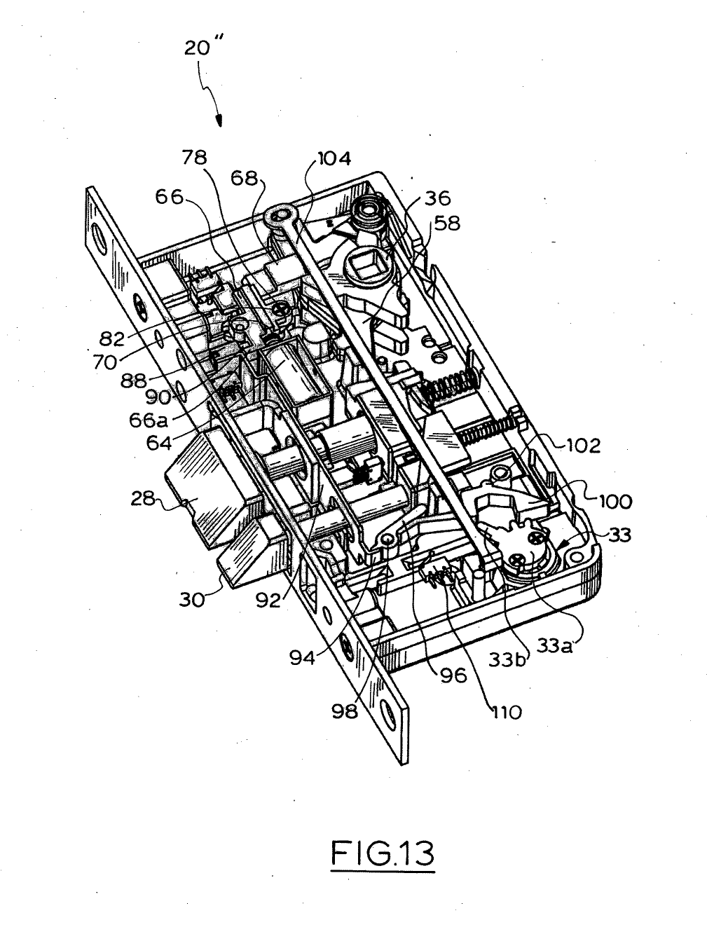

FIG. 13 shows a third embodiment of a lock assembly 20″ in which it is possible to remove external electric control to the first and/or second solenoids and also move the first hub locker 68 from the position it is placed in by the fail safe or fail secure setting of the lock assembly. Accordingly, the correct key can be used to do one of locking or unlocking.

FIG. 13 shows the lock assembly 20″ after starting in a condition similar to that shown in FIG. 8 (i.e. set to fail safe, the solenoid 64 not energised and thus unlocked) but that has now been acted upon by the key operated manual override function. When the correct key is used to pivot the key cylinder cam 33a and thus pivot the key driven lever 100 in a clockwise direction, the sensor 110 triggers the removal of external control from the first solenoid 64. The lockbar 90 is sitting in the extended position. As the manual override slide 92 is drawn downwards, the engagement between the lockbar 90 and the tab 66a will cause the first motion transfer mechanism 66 to drive the first hub locker 68 into the extended position preventing rotation of the first hub 36. As a result, the lock assembly 20″ is locked from the first side.

If the lock assembly 20″ had instead been set to a fail secure, then the same movement of the manual override slide 92 would have instead unlocked the first hub 36. Accordingly, the sensor 110 is able to be used to disable remote electrical locking/unlocking, allowing the key operated manual override function to advantageously be used to independently invert the lock state as desired.

The above described lock assemblies have electrically powered hub locker assemblies (ie. locking/unlocking mechanisms) and also include a manually driven assembly (ie. key operated manual override function or mechanical locking/unlocking mechanism). The mechanical mechanism can advantageously be used to change the state of the lock assembly or to prevent the electrical control system from changing the lock assembly's lock/unlock state.

The key operated manual override function can be used in three ways. Firstly, the function can be used to only block or remove a remote signal from influencing the electrically powered hub locker assemblies (eg. solenoids/motors etc) so that: 1) if there is no remote signal at the time of manual overriding the state of the lock assembly does not change; 2) if there is a remote signal at the time of manual overriding and the actuator has a biased position then the solenoid will revert to the biased position; or 3) if there is a remote signal at the time of manual overriding and the actuator has two stable positions (ie. no biased position) then the state of the lock assembly does not change.

Alternatively, the function can physically change the position of the mechanical components that the electrically powered hub locker assemblies use to lock or unlock the lock regardless of a signal being applied or not being applied to the electrically powered hub locker assemblies.

As a result, the above described lock assemblies, when set to operate as fail safe, are still able to be used to lock the door in the absence of power. This obviates the need for a security guard or a separate manual lock to secure the door until power is returned. Further, when set to operate as fail secure, they are able to be used to unlock the door in the absence of power. This allows the normal operation of a door to continue in the absence of power.

The lock assembly embodiments described above are advantageous in many applications such as:
during the fitting out of a building when the door control/monitoring electrics are not yet installed or fully operational. If the lock assembly is set to fail safe (ie. unlocked when no power) then the manual override function can be used to lock the door after hours. If the lock is set to fail secure (ie. locked when no power) then the manual override system can be used to unlock the door during working hours;
changing the lock assembly's status at any time when the power supply is interrupted, so the lock can still perform lock/unlock functions and keep a building's activities going until the electrical systems are restored;
during normal powered operation, giving a manual override option;

providing a signal from within the lock assembly and sending it to the building monitoring system to show the manual key override function has been used during normal powered operation;
the remote electrical locking/unlocking of the lock assembly by an external signal powering the solenoid can be disabled internally in the lock by use of the key. Thereafter the electrically powered hub locker assemblies are de-energised and adopt whatever position that the fail safe/fail secure settings encourage. At this time the override mechanism can either leave the electrically powered hub locker assemblies in this biased position or move it to its other position;
choosing whether or not the manual override function moves the hub locker or not at installation or at any time later without removing the lock from the door and whether the override mechanism removes external control from the solenoid or not is also switch selectable before installation or at any time after without removing the lock from the door; and
with the addition of an additional switch on the front edge of the lock assembly that is accessible once the door is open, the remote electrical locking/unlocking of the lock by an external signal can be disabled for as long as manual key control is desired without removing the lock from the door.

Although the invention has been described with reference to preferred embodiments, it will be appreciated by persons skilled in the art that the invention can be embodied in many other forms. For example, the embodiments of lock assembly described above use independent first and second electrically powered hub locker assemblies for each side of the lock and a single manually driven assembly (ie. key operated manual override function) which can interact with each of the first and second electrically powered hub locker assemblies. In other embodiments (not shown) both of the hubs can be locked/unlocked by a single electrically powered hub locker assembly and/or independent first and second manually driven assemblies (ie. key operated manual override functions). In a further embodiment (not shown), the first and second adjustment ports are positioned s on the sides or the top, bottom or rear edges of the lock assembly, so as not to be accessible via removal of the face plate.

1. A lock assembly including:
a lock bolt movable between a latching position and an unlatching position;
a first hub adapted to move the lock bolt in response to movement of a first handle;
a first electrically powered hub locker assembly positionable to selectively prevent or allow movement of the lock bolt in response to torque being applied to the first handle, the first electrically powered hub locker assembly being connectable to a first power source; and
a first manually driven assembly adapted for selectively preventing or allowing transmission of power from the first power source to the first electrically powered hub locker assembly.

2. The lock assembly as claimed in claim 1, wherein the lock assembly includes a housing and the lock bolt, the first hub, the first electrically powered hub locker assembly and the first manually driven assembly are mounted within the housing.

3. The lock assembly as claimed in claim 1, wherein the first manually driven assembly is driven by a key or a turn button.

4. The lock assembly as claimed in claim 1, wherein the first electrically powered hub locker assembly is adapted for powered driving in a first direction to a first position and biased driving in a second direction opposite to the first direction to a second position, wherein the first electrically powered hub locker assembly remains at, or returns to, the second position when the first manually driven assembly is driven to prevent transmission of power to the first electrically powered hub locker assembly.

5. The lock assembly as claimed in claim 1, wherein the first electrically powered hub locker assembly is adapted for powered driving in a first direction to a first position and powered driving in a second direction opposite to the first direction to a second position, wherein the electrically powered hub locker assembly remains at the position it was occupying when the first manually driven assembly is driven to prevent transmission of power to the first electrically powered hub locker assembly.

6. The lock assembly as claimed in claim 1, wherein the lock assembly includes:
a second hub adapted to move the lock bolt in response to movement of a second handle,
wherein the first electrically powered hub locker assembly is positionable to selectively prevent or allow movement of the lock bolt in response to torque being applied to the second handle.

7. The lock assembly as claimed in claim 1, wherein the lock assembly includes:
a second hub adapted to move the lock bolt in response to movement of a second handle; and
a second electrically powered hub locker assembly positionable to selectively prevent or allow movement of the lock bolt in response to torque being applied to the second handle, the second electrically powered hub locker assembly being connectable to the first power source,
wherein the first manually driven assembly is adapted for selectively preventing or allowing transmission of power from the first power source to the second electrically powered hub locker assembly.

8. The lock assembly as claimed in claim 1, wherein the lock assembly includes:
a second hub adapted to move the lock bolt in response to movement of a second handle; and
a second electrically powered hub locker assembly positionable to selectively prevent or allow movement of the lock bolt in response to torque being applied to the second handle, the second electrically powered hub locker assembly being connectable to a second power source,
wherein the first manually driven assembly is adapted for selectively preventing or allowing transmission of power from the second power source to the second electrically powered hub locker assembly.

9. The lock assembly as claimed in claim 7, wherein the second electrically powered hub locker assembly is adapted for powered driving in a first direction to a first position and biased driving in a second direction opposite to the first direction to a second position, wherein the second electrically powered hub locker assembly remains at, or returns to, the second position when the first manually driven assembly is driven to prevent transmission of power to the second electrically powered hub locker assembly.

10. (canceled)

11. The lock assembly as claimed in claim 1, wherein the lock assembly includes:
a second hub adapted to move the lock bolt in response to movement of a second handle;
a second electrically powered hub locker assembly positionable to selectively prevent or allow movement of the lock bolt in response to torque being applied to the second handle, the second electrically powered hub locker assembly being connectable to a second power source; and
a second manually driven assembly adapted for selectively preventing or allowing transmission of power from the second power source to the second electrically powered hub locker assembly.

12. The lock assembly as claimed in claim 11, wherein the second hub and the second electrically powered hub locker assembly are mounted within the housing.

13-30. (canceled)

31. The lock assembly as claimed in claim 1, wherein the first manually driven assembly includes a first engagement means settable in a first position engaging the first electrically powered hub locker assembly or in a second position not engaging the first electrically powered hub locker assembly, wherein movement of the first manually driven assembly whilst the first engagement means is in the first position causes movement in the first electrically powered hub locker assembly.

32. (canceled)

33. (canceled)

34. The lock assembly as claimed in claim 31, wherein the lock assembly includes a front face with a first opening for providing access to the first engagement means.

35-48. (canceled)

49. A lock assembly including:
a lock bolt movable between a latching position and an unlatching position;
a first hub adapted to move the lock bolt in response to movement of a first handle;
a first electrically powered hub locker assembly positionable to selectively prevent or allow movement of the lock bolt in response to torque being applied to the first handle; and
a first manually driven assembly adapted for moving the first electrically powered hub locker assembly from:
a position preventing movement of the lock bolt in response to torque being applied to the first handle to a position allowing movement of the lock bolt in response to torque being applied to the first handle; or
a position allowing movement of the lock bolt in response to torque being applied to the first handle to a position preventing movement of the lock bolt in response to torque being applied to the first handle.

50. The lock assembly as claimed in claim 49, wherein the lock assembly includes a housing and the lock bolt, the first hub, the first electrically powered hub locker assembly and the first manually driven assembly are mounted within the housing.

51. The lock assembly as claimed in claim 49, wherein the first manually driven assembly is driven by a key or a turn button.

52. The lock assembly as claimed in claim 49, wherein the first electrically powered hub locker assembly remains in the position it is moved to by the manual operation of the first manually driven assembly until subsequently acted upon by further manual operation of the first manually driven assembly.

53. The lock assembly as claimed in claim 49, wherein the lock assembly includes:
a second hub adapted to move the lock bolt in response to movement of a second handle,
wherein the first electrically powered hub locker assembly is positionable to selectively prevent or allow movement of the lock bolt in response to torque being applied to the second handle, and
the first manually driven assembly is adapted for moving the first electrically powered hub locker assembly from:
a position preventing movement of the lock bolt in response to torque being applied to the second handle to a position allowing movement of the lock bolt in response to torque being applied to the second handle; or
a position allowing movement of the lock bolt in response to torque being applied to the second handle to a position preventing movement of the lock bolt in response to torque being applied to the second handle.

54-55. (canceled)

56. The lock assembly as claimed in claim 49, wherein the lock assembly includes:
a second hub adapted to move the lock bolt in response to movement of a second handle;
a second electrically powered hub locker assembly positionable to selectively prevent or allow movement of the lock bolt in response to torque being applied to the second handle; and
a second manually driven assembly adapted for moving the second electrically powered hub locker assembly from:
a position preventing movement of the lock bolt in response to torque being applied to the second handle to a position allowing movement of the lock bolt in response to torque being applied to the second handle; or
a position allowing movement of the lock bolt in response to torque being applied to the second handle to a position preventing movement of the lock bolt in response to torque being applied to the second handle.

57. The lock assembly as claimed in claim 56, wherein the second hub and the second electrically powered hub locker assembly are also mounted within the housing.

58-88. (canceled)

89. The lock assembly as claimed in claim 49, wherein the lock assembly includes:
a second hub adapted to move the lock bolt in response to movement of a second handle,
wherein the first electrically powered hub locker assembly is positionable to selectively prevent or allow movement of the lock bolt in response to torque being applied to the second handle.

90. The lock assembly as claimed in claim 49, wherein the lock assembly includes:
a second hub adapted to move the lock bolt in response to movement of a second handle; and
a second electrically powered hub locker assembly positionable to selectively prevent or allow movement of the lock bolt in response to torque being applied to the second handle, the second electrically powered hub locker assembly being connectable to the first power source,
wherein the first manually driven assembly is adapted for selectively preventing or allowing transmission of power from the first power source to the second electrically powered hub locker assembly.

91. The lock assembly as claimed in claim 49, wherein the lock assembly includes:
a second hub adapted to move the lock bolt in response to movement of a second handle;
a second electrically powered hub locker assembly positionable to selectively prevent or allow movement of the lock bolt in response to torque being applied to the second handle, the second electrically powered hub locker assembly being connectable to a second power source; and
a second manually driven assembly adapted for selectively preventing or allowing transmission of power from the second power source to the second electrically powered hub locker assembly.

92-93. (canceled)
